(19) United States
(12) Patent Application Publication
(10) Pub. No.: US 2013/0334025 A1
(43) Pub. Date: Dec. 19, 2013

(54) HIGH-PERFORMANCE DIFFUSION MULTIPLE-EFFECT DISTILLATION SYSTEM

(71) Applicants: Bin-Juine Huang, Taipei (TW); Jong-Fu Yeh, Taipei (TW); Shih-Lin Chang, Taipei (TW)

(72) Inventors: Bin-Juine Huang, Taipei (TW); Jong-Fu Yeh, Taipei (TW); Shih-Lin Chang, Taipei (TW)

(73) Assignee: Huang, Bin-Juine

(21) Appl. No.: 13/494,995

(22) Filed: Jun. 13, 2012

(51) Int. Cl. B01D 3/02

(52) U.S. Cl. 202/174

(57) ABSTRACT

A high-performance diffusion multiple-effect distillation system, which comprising: a few distillers, a heating device and a water make-up device; said distiller is composed of several laminar distillation sheets, with one surface taken as a condensing surface, and the other surface attached with an evaporating sheet; a collecting ditch is set below the condensing surface; and the periphery of the distillation sheets is provided with a supporting structure; the heating device is provided with several heating surfaces; the heating surface and the condensing surface of corresponding distillation sheet have a good thermal contact, the water make-up device is provided with at least a water tank filled with water to be distilled and at least a water make-up body.

### BACKGROUND OF INVENTION

1. Field of the Invention

The present invention relates generally to a high-performance diffusion multiple-effect distillation system, and more particularly to an innovative one which is applied to water purification, seawater desalination, waste recovery and solar energy utilization.

2. Description of Related Art

Diffusion multiple-effect distillation system, developed by Cooper and Appleyard in 1967, is a high-performance, thermally driven distilled water system [P. I. Cooper and J. A. Appleyard. Sun at Work 12 (1967), p. 4.].

As shown in FIG. 1, a conventional diffusion multiple-effect distillation system mainly comprises: a conventional heating device (A), a conventional water make-up device (B) and overlapped conventional distillation sheets (C).

Of which, conventional distillation sheets (C) is the most important element with a smooth surface taken as a conventional condensing surface (C1) for vapour condensation; a conventional collecting ditch (D) is set below the conventional condensing surface (C1) to collect distilled water (DW) of condensed vapour (HW) dripped from said conventional condensing surface (C1);

a conventional evaporating sheet (C2) of capillary material is attached onto the other surface; the conventional water make-up device (B) supplies water (W) to be distilled, which is absorbed by the conventional evaporating sheet (C2) and then evaporated;

the conventional distillation sheets (C) are overlapped in a way that the conventional condensing surface (C1) of conventional distillation sheet (C) faces the conventional evaporating sheet (C2) of the other one, and the sidelines are aligned, allowing for parallel arrangement at close interval;

an outward conventional condensing surface (C1), abutted with the conventional heating device (A); the conventional heating device (A) could heat up the nearby conventional distillation sheet (C) using the heat energy (H) of external heat sources [e.g.: solar energy, vapour], so the conventional distillation sheets (C) have maximum temperature; water (W) adsorbed on the conventional evaporating sheet (C2) absorbs heat energy (H), and then is evaporated into vapour (HW), which is diffused onto the conventional condensing surface (C1) of opposite conventional distillation sheet (C) and condensed into distilled water (DW);

latent heat released from the condensation process is also a heat source of the conventional distillation sheet (C), which is transferred to another nearby conventional evaporating sheet (C2), such that water (W) therein is evaporated; the evaporation process is repeated until the last conventional distillation sheet (C) to discharge heat energy from the system; so the last conventional distillation sheet (C) has the minimum temperature.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### SUMMARY OF THE INVENTION

The present invention is described in detail with reference to the accompanying drawings:

FIG. 2 shows a schematic view of the first preferred embodiment of the present invention; FIG. 3 shows an exploded perspective view of the first preferred embodiment of the present invention; FIG. 4 shows a sectional view of the first preferred embodiment of the present invention; FIG. 5 shows a sectional view of the present invention showing the application status of the first preferred embodiment; FIG. 15 shows a perspective view of the first preferred embodiment of another utility model; FIG. 17 shows a perspective view of the fifth preferred embodiment; and FIG. 18 shows a perspective view of the sixth preferred embodiment.

According to the first technical means disclosed above, the high-performance diffusion multiple-effect distillation system is characterized by that, it comprising:

A distillation system 100, comprising of a few distillers 1, a heating device 2 set between said distillers 1, and a water make-up device 3 set at top of the distiller 1;

Said distiller 1 is composed of several distillation sheets 11; the distillation sheet 11 is of laminar structure, with its one surface taken as a condensing surface 12 for vapour (HW) condensation, and the other surface attached with an evaporating sheet 13 made of capillary material for evaporation purpose; water (W) to be distilled from the water make-up device 3 can be adsorbed onto the evaporating sheet 13; a collecting ditch 15 is set below the condensing surface 12 to collect distilled water (DW) dripped from said condensing surface 12; the distillation sheets 11 are arranged in parallel away from the heating device 2 in the sequence of condensing surface 12 and evaporating sheet 13; and the periphery of the distillation sheets 11 is provided with a supporting structure 16 for preventing leakage of the vapour (HW); the heat energy from the corresponding heating device 2 is transferred to the condensing surface 12 of the distillation sheet 11 closest to the heating device 2; and the heat energy is transferred to the evaporating sheet 13 of the distillation sheet 11 through the condensing surface 12, such that water (W) adsorbed on the evaporating sheet 13 is evaporated into vapour (HW), which is then diffused to the condensing surface 12 of opposite distillation sheet 11 and condensed into distilled water (DW); when the vapour (HW) is condensed into distilled water (DW), the released latent heat is transferred to the evaporating sheet 13 of the distillation sheet 11, where water (W) contained therein is evaporated into vapour (HW); similarly, vapour (HW) will be diffused to the condensing surface 12 of a distillation sheet 11 opposite to the aforementioned distillation sheet 11 and condensed into distilled water (DW); the distillation process is repeated until the heat energy is discharged out of the distillation system 100 from the farthest distillation sheet 11 of the heating device 2;

said heating device 2 is provided with several heating surfaces 21; the heating surface 21 and the condensing surface 12 of corresponding distillation sheet 11 of the distiller 1 have a good thermal contact, or are incorporated to convert any kind of energy entering the heating device 2 into heat energy, and then transfer to the corresponding distiller 1 through the heating surface 21;

said water make-up device 3 is provided with at least a water tank 31 filled with water (W) to be distilled, and at least a water make-up body 32 made of capillary material; the level of water (W) in the water tank 31 is higher than the lowest point of said evaporating sheet 13; one end of the water make-up body 32 is dipped in water (W) of the water tank 31, and the other end is connected with the top of the evaporating sheet 13, enabling to guide water (W) from the water tank 31 to the evaporating sheet 13;

the distillation sheet 11 is provided with an arced surface 14, of which the concave surface is condensing surface 12, and the evaporating sheet 13 is covered onto the convex surface; moreover, evaporating sheet 13 is tightened at both ends of the arced surface 14 such that the evaporating sheet can be attached closely onto the distillation sheet 11.

Of which, high-performance diffusion multiple-effect distillation system is divided into four parts: namely, heating device 2, water make-up device 3, distiller 1 and heat recovery device 4, each of which can be operated individually and repaired/replaced separately; and all capillary elements [evaporating sheet 13 and/or water make-up body 32] can be individually disassembled or replaced.

Next, with the mechanical structure of the arced distillation sheets, it is only required to fix separately the evaporating sheet 13 onto various distillation sheets 11, which are then overlapped to finish the assembly process; the distillation sheet 11 or evaporating sheet 13 can also be disassembled or repaired individually, presenting rather convenience in assembly and maintenance.

Furthermore, capillary material is covered onto all distillation sheets 11 as a water make-up body 32, with its underside kept in contact with the evaporating sheet 13 on every distillation sheet 11; besides, one end of the water make-up body 32 is dipped in water (W) of the water tank 31, and the other end is kept contact with the upper side of the evaporating sheet 13 of all distillation sheets 11; water is infiltrated downwards and laterally from the inlet of the water make-up body 32, and the evaporating sheet 13 absorbs water from the bottom of the water make-up body 32; a level switch 33 is set in the water tank 31 to regulate the water level; if proper capillary material and sectional area for water make-up body 32 are selected, the feed water to the water make-up body 32 could be controlled according to the level in the water tank 31; if the water make-up body 32 is too dirty, it is just required to take it out for cleaning or replacement, without need of disassembling the distillation sheet 11.

Furthermore, with use of several distillers 1, the distillation efficiency of the present invention could be improved applicably as compared with conventional diffusion multiple-effect distillation system.

Said distillation sheets 11 could be assembled securely by either of the following ways: snapping, sleeving and screwing;

Said evaporating sheets 13 could be attached securely onto the distillation sheets 11 through fixing two ends by either of the following ways:

Clamped between two ends of the distillation sheets 11; gripped between two nearby distillation sheets 11; embedded simultaneously between two nearby distillation sheets 11 during assembly.

Of which, different installation modes could be used to make the overall structure of the present invention cater for the demands of different manufacturers.

Said distillation sheets 11 are fabricated by either of the following sheets: flexible metal sheet, inflexible metal sheet, flexible high polymer sheet and inflexible high polymer sheet.

Of which, different types of distillation sheets 11 are used, so various pressure and temperature ratings are formed to meet the needs of different manufacturers.

Of which, the heating device 2 is a tank 24, which is connected via a pipeline 300 with the heat source 200 of the distillation system 100, so as to obtain heated vapour (HDW) transferred from the heat source 200;

said tank 24 is provided with at least a vapour inlet 24B, which is connected via a pipeline 300 with the heat source 200 of the distillation system 100, allowing the heating medium (HC) from the heat source 200 to enter into the tank 24 through the pipeline 300;

moreover, said tank 24 is provided with several openings 24A, so it can be used as a heating surface 21; with this structure, the condensing surface 12 of the distillation sheet 11 can be attached closely onto the tank 24 and covered onto the openings 24A.

Such operating mode is suitable for heat source 200 of smaller pressure, since the simple construction could reduce the overall cost, raise the desire of the manufacturers for installation, and cut down environmental pollution.

FIG. 6 shows a perspective view of the second preferred embodiment of the present invention; FIG. 7 shows an exploded perspective view of the second preferred embodiment of the present invention; FIG. 8 shows a sectional view of the second preferred embodiment of the present invention; FIG. 16 shows a perspective view of a fluid container of another heating device.

As disclosed in the aforementioned drawings, a fluid container 23, which comprises of an inlet 23A and outlet 23B for guiding of heating medium (HC), is distributed on the back of the heating surface 21 of said heating device 2; said fluid container 23 and the heating surface 21 have a good thermal contact, or are incorporated.

Referring to FIG. 8, the fluid container 23 of the heating device 2 is of a coiled configuration mode, so the fluid container 23 is attached closely onto the back of the heating surface 21; referring to FIG. 16, the fluid container 23 of the heating device 2 is of a box-type configuration mode, so at least one surface of the fluid container 23 is directly used as the heating surface 21.

After any kind of heating medium (HC) enters into the fluid container 23 from the inlet 23A of the fluid container 23, the heat of the heating medium (HC) is transferred to the corresponding heating surface 21, and taken away by the distiller 1; the heating medium (HC) after heat removal exits from the outlet 23B of the fluid container 23;

an evaporating sheet 21A is covered between the heating surface 21 and nearby distillation sheet 11.

With such heating device 2, different heating medium (HC) can be used to increase the versatility of the present invention in combination with different devices.

FIG. 9 shows a perspective view of the third preferred embodiment of the present invention; FIG. 10 shows an exploded perspective view of the third preferred embodiment of the present invention; FIG. 11 shows a sectional view of the third preferred embodiment of the present invention.

Of which, said heating device 2 is a solar heating device 22;

said solar heating device 22 is composed of several heat absorbing surfaces 22A and a hood 22B set at light incident side of the heat absorbing surface 22A; the heat absorbing surface 22A of dark color is used to absorb sunlight (L), while the hood 22B enables the sunlight (L) to transfer and/or concentrate on the heat absorbing surface 22A.

Of which, with the use of the heating device 2, the distillation system 100 is a most environmental-friendly modern system that can prevent secondary pollution during distillation.

FIG. 12 shows a perspective view of the fourth preferred embodiment of the present invention; FIG. 13 shows an exploded perspective view of the fourth preferred embodiment of the present invention; FIG. 14 shows a sectional view of the fourth preferred embodiment of the present invention.

As disclosed in the aforementioned drawings, an electric heating device 25 is set on the heating surface 21 of said heating device 2, and used to convert electric energy into heat energy, and transfer to the distiller 1 through the heating surface 21;

and, an evaporating sheet 21A is covered between the heating surface 21 and nearby distillation sheet 11.

When such electric heating device 25 is easily installed as a heating device 2, the energized electric heating device 25 could convert electric energy into heat energy (H) for the distiller 1.

According to the aforementioned drawings, the difference between the first and second technical means lies in that:

the water make-up body 32 of said water make-up device 3 can be disassembled or replaced individually, and the water make-up body 32 is not prefabricated or fixed with said evaporating sheet 13.

With such operating mode, it is possible to realize individual disassembly, replacement or maintenance of the water make-up body 32, thus reducing the maintenance difficulty and cost.

According to the aforementioned drawings, the difference between the first and third technical means lies in that:

said distillation system 100 also comprises at least a heat recovery device 4;

said heat recovery device 4 comprises of a heat exchanger 41, which permits to preheat water (W) to be distilled by the residual heat from the waste water of distillation system 100 or from the distilled water (DW), or preheat the heat source 200 of the distillation system 100, and transfer heat energy to the heating medium (HC) of the heating device 2;

the heat exchanger 41 of the heat recovery device 4 comprises at least a fluid pipeline 42 with its one end linked to the water tank 31, or

the heat source 200 of the distillation system 100; and

a fluid-choking device 43 made of capillary material for recycling the waste heat generated by the distillation system 100, covered onto the fluid pipeline 42, and capable of absorbing the waste heat from the distillation system 100 as well as heat exchange with the fluid pipeline 42.

Of which, the heat recovery device 4 is located underneath all the distillation sheets 11, and the fluid-choking device 43 of the heat exchanger 41 made of capillary material is paved onto a water tray 44 after heat insulation; the water tray is provided with two oblique sides, of which the higher side is close to the heating device 2, and the lower side close to the outward distillation sheet 11; the fluid pipeline 42 is spirally buried into the fluid-choking device 43.

Next, water (W) to be distilled or heating medium (HC)[fluid A] is fed from the inlet of the lower fluid pipeline 42, and discharged from the outlet of the highest fluid pipeline 42, and then conveyed to the water make-up device 3 or external heat source 300, so as to supplement water (W) or the heating medium (HC);

water (W) [fluid B] from the upper evaporating sheet 13 can be directly dripped onto the fluid-choking device 43, or the evaporating sheet 13 is extended to contact with the fluid-choking device 43, such that residual water (W) is absorbed by capillary force; the temperature of water (W) generated by every piece of distillation sheet 13 is different, namely, the temperature of water closer to the heating device 2 is higher;

the design of the heat recovery device 4 is characterized by that, the temperature gradient of the fluid-choking device 43 is contrary to the flow direction of water within the fluid pipeline 42, ensuring that returned water (W) or heating medium (HC) exiting the fluid pipeline 42 has maximum temperature; and, since the fluid-choking device 43 is set obliquely, water (W) [fluid B] from the upper evaporating sheet 13 can only flow from high-temperature zone to low-temperature zone, thus preventing efficiently the mixing of water (W) with different temperature and guaranteeing the minimum temperature of water (W) exiting the fluid-choking device 43.

According to the aforementioned drawings, the difference between the first and fourth technical means lies in that:

a diversion strip 15A is set separately into the collecting ditch 15 of the distillation sheet 11; the diversion strip 15A made of capillary material is extended out of the lowest outlet 15B of the collecting ditch 15, so as to discharge the distilled water (DW) of the collecting ditch 15.

Of which, the distilled water (DW) is discharged by the capillary principle; a slender capillary material is paved at the bottom of the collecting ditch 15 as the diversion strip 15A, which is extended to the lowest outlet 15B of the collecting ditch 15; the diversion strip 15A is slightly longer than the collecting ditch 15, so it can be extended out of the outlet; distilled water (DW) on the condensing surface 12 is dripped onto the diversion strip 15A, which could absorb quickly the distilled water (DW) by the capillary force, and diffuse it towards both sides; after the diversion strip 15A is saturated, distilled water (DW) will be discharged from the lowest outlet 15B by the gravitational force; in order to increase water discharge speed, the collecting ditch 15 is designed to be tilted towards the outlet 15B, and the discharge force for the distilled water (DW) is increased with the help of gravitational force; since the dripping of distilled water (DW) to the collecting ditch 15 and its discharge is locked within the diversion strip 15A, no overfilling or overspilling out of the collecting ditch 15 occurs, thus increasing the yield or purity of distilled water (DW); as collecting ditch 15 of higher wall is not required, the collecting ditch 15 is of a robust structure without requiring higher fabrication accuracy.

According to the descriptions above, the present invention has the following advantages:

1. A modular design concept of high-performance diffusion multiple-effect distillation system is proposed for the purpose of actual application; the system is divided into four parts: heating device, water make-up device, distiller and heat recovery device; of which the heating device is used to obtain external heat and provide the heat source for evaporation to make distilled water; the water make-up device is used to convey water to the distiller, where heat energy from the heating device allows to vaporize water into vapour, and then condense into distilled water; the distiller comprises a plurality of distillation sheets, which could heat up and evaporate water from the water make-up device, and then condense into distilled water; the heat recovery device is used to recover the waste water generated by the system and residual heat of distilled water; every component can be operated individually and repaired/replaced separately; and all capillary elements can be individually disassembled or replaced; so such modular design facilitates assembly and disassembly/replacement of components, thus reducing the maintenance cost; in particular, the capillary components in the system are consumables, the design for individual disassembly/replacement permits to disassemble and clean up easily the components, thus extending markedly the service life and reducing greatly the maintenance cost with improved applicability.

2. The spacing between distillation sheets must be reduced properly to obtain better efficiency, and also prevent the condensed water from keeping contact with the opposite evaporating sheets; according to the test, the optimum spacing is about 5 mm, rather small as compared with the area of the distillation sheets; in order to maintain a proper distance between two distillation sheets, the distillation sheets are generally made of solid or thick materials, placing some limitations on the selection and weight of materials; on the other hand, the capillary material must be attached closely onto the distillation sheet so as to prevent separation of the evaporating sheet from the condensing surface to keep contact with the opposite condensing surface (causing pollution to distilled water), and also obtain optimum heat transfer effect; the capillary material is generally fastened by adhesive, causing some difficulty in replacement of the capillary material; moreover, the adhesive could also cause damage to the capillary force and pollution to water, meanwhile the additional weight will also reduce the heat conductivity; so the mechanical structure concept of arced distillation sheets could solve the aforementioned problems; in the present invention, the distillation sheet is of a quadrilateral laminar structure with arced surface, where the capillary material is covered onto the convex surface as evaporating sheet; then, the evaporating sheet is tightened linearly onto the arced surface, such that all points of the evaporating sheet on the arced surface yield a static component pointing to the center of circle, and the evaporating sheet is thus attached closely onto the distillation sheet; disassembly or replacement of evaporating sheet is easy since no adhesive is used to fix the evaporating sheet; if four sides of a plain sheet and an arced surface of the same material are supported securely, the arced surface has a stronger intermediate structure, onto which a smooth arc could be maintained without deformation; another advantage of such structure is that, the desired strength could be reached with very thin distillation sheets; with the reduction of thickness, it is possible to improve the heat conductivity and reduce greatly the weight; since no limitation is made on the material of good conductivity, there is a good freedom in selection of cost-saving materials.

3. Due to small spacing of two conventional distillation sheets, the space of conventional collecting ditch below the conventional condensing surface is very limited; so the cohesion and adhesion of water is bigger than the gravitational force, and the distilled water is choked in the ditch; in the case of overflooding, water may get into contact with nearby conventional evaporating sheet, so the distilled water will be absorbed by the conventional evaporating sheet, leading to reduce of yield and also pollution by water on the conventional evaporating sheet; on the other hand, the dripping water is probably spilled out of the ditch due to small space; the ditch wall could also be raised to improve the yield and purity of distilled water, however, a higher ditch wall will weaken the structural strength of the collecting ditch; moreover, higher fabrication accuracy is required to ensure that the dripping water enters smoothly into the ditch; so a simple but efficient method is proposed in the present invention, namely, distilled water is discharged by capillary principle; and a capillary material is placed into the collecting ditch as a diversion strip, which is extended to the lowest outlet; distilled water on the condensing surface drips onto the diversion strip, which could absorb quickly water by the capillary force and diffuse towards both sides; after the diversion strip is saturated, water is discharged from the lowest outlet with the help of gravitational force; in order to speed up water discharge, the collecting ditch is designed to be tilted towards the outlet, thus increasing the discharge momentum by the gravitational force; since the dripping of distilled water to the collecting ditch and its discharge is locked within the diversion strip, no overfilling or overspilling out of the collecting ditch occurs, thus increasing the yield or purity of distilled water; since no collecting ditch of higher wall is required, the collecting ditch has a stronger structure without need of higher fabrication accuracy.

4. Numerous impurities are dissolved in water when the distiller is extensively applied to seawater desalination. In order to avoid crystallization of impurities on the capillary material with reduced efficiency, fresh water must be added constantly and condensed waste water must be discharged along with numerous residual heat contained in the waste water; on the other hand, numerous residual heat is also contained in the distilled water generated by the distiller; such heat will be wasted in the absence of heating requirement; with use of the heat recovery device, the residual heat of waste water and distilled water could be used to preheat fresh water to be distilled, or preheat the medium of transferring heat from the heat source to the heating device so as to improve the system efficiency; when heat recovery is required during operation of the distillation system, the flux and flow rate of fluid for heat exchange is very small; in such conditions, only through small-volume conventional heat exchanger could better heat exchange effect be achieved, but this will increase the difficulty in fabrication and maintenance; on the other hand, the temperature of waste water generated by every piece of distillation sheet and the distilled water is different, namely, the temperature closer to the heating device is higher, or vice versa; if hot water of different temperature is mixed and then subject to heat exchange, the heat recovery effect will be cut down; if heat exchanger is set individually for hot water of different temperature, the heat recovery device will be much complicated to increase greatly the cost; so the concept of capillary heat exchanger is proposed in the present invention; a layer of capillary material is covered onto fluid A pipeline as the fluid-choking device, into which fluid B containing waste heat is guided; then fluid B moves along the fluid-choking device and then is discharged at the lowest point; fluid A of lower temperature in the pipeline and fluid B of higher temperature on the fluid-choking device have a heat exchange for the purpose of heat recovery; if necessary, the fluid-choking device could be designed into stripped, laminar or blocky patterns, while the pipeline could also be spirally buried into the fluid-choking device in any form where necessary; the fluid-choking device of an open structure could be designed to meet different needs, allowing fluid B to enter into it from any position; if fluid B of higher temperature enters into higher position of the fluid-choking device, and that of lower temperature enters into lower position of the fluid-choking device, the flow of fluid B from high-temperature to low-temperature zone will prevent efficiently the mixing of fluid with various temperature; in addition, if fluid A pipeline's inlet is set at the place with maximum temperature difference within and outside the pipeline, and fluid A pipeline's outlet set at the place with minimum temperature difference, small flow rate and flux of fluid B will not cause overspilling of fluid B in the fluid-choking device, so this structure could bring about excellent heat exchange efficiency; hence, the capillary heat exchanger is particularly suitable for highly efficient heat recovery mechanism specific to high-performance diffusion multiple-effect distillation system; the capillary heat exchanger of simple construction could save the fabrication cost.

5. The flow rate of water on every piece of evaporating sheet must be appropriate, since extremely small flow rate will cause crystallization of impurities on the capillary material, and extremely big flow rate will lead to loss of excessive heat and reduction of efficiency; water evaporation on the evaporating sheet varies with the changing heat of the heat source; the heat source commonly referred to [e.g.: solar energy] is not a stable heat source; meanwhile, the evaporation of evaporating sheets is poor and irregular under unstable conditions and various operating status; so a key technology has to be developed to ensure proper flux on every evaporating sheet by setting of auto regulation and distribution of water make-up; one end of the capillary material is dipped in water, and the other end extended out of the tank, so water in the tank will flow continuously out of the tank along the capillary material due to the capillary force and gravitational force; the flow rate of water is proportional to the capillary force, sectional area, water level, potential difference of outlet and moisture content of capillary material, but inversely proportional to the distance between the water level and the highest turn point; so this is a most simple and efficient way for making up water for distillation sheet; traditionally, the capillary material on the distillation sheet is extended to the water tank and dipped in water; the spacing between the evaporating sheets and the water tank is not equal, and orderly arrangement is required, so the assembly is a little difficult; on the other hand, the suspended insoluble impurities will be locked at the opening of the capillary material, leading to early failure of entire capillary material and time-consuming replacement; according to the concept of the present invention that capillary for water make-up is separated from the capillary material on the distillation sheet, an entire piece of capillary material is covered onto all distillation sheets as a water distributor, with its underside kept in contact with the evaporating sheet on every distillation sheet; one end of the capillary material is dipped in water of the water tank, and the other end gets into contact with the top of water distributor as a water feeder; the water distributor and water feeder can be prefabricated integrally, or set separately; water is infiltrated downwards and laterally from the inlet of the water distributor, and the evaporating sheet absorbs water from the bottom of the water distributor; if proper capillary material and sectional area for water feeder are selected, the water feed could be controlled according to the level in the water tank; the capillary material could block off suspended insoluble impurities in water, so the water feeder serves as the first filter, and the water distributor serves as the second filter; if preliminary filtering is done before water enters into the distillation sheet, the service life of the evaporating sheet could be prolonged; if the water feeder and water distributor are too dirty, it is just required to take out for cleaning or replacement, without need of traditional disassembly of entire distillation sheets.

6. The distiller is a consumable as compared with the heating device, but conventional heating device and conventional distiller are generally designed into an integrated part, so conventional diffusion multiple-effect distillation system causes difficulty in maintenance; although different types of heat sources are theoretically available, the conventional integrated design needs to be matched with the entire system, so the heating device is often used by means of direct solar radiation or indirect radiation, and the range of application of the distiller is limited; hence, according to the concept of the present invention, the heating device and the distiller are independently operated as a single system; in such way, the heating device could be designed and fabricated individually, and the same set of distiller could be used in line with different heating devices, so the heat sources can be used flexibly; if solar energy is used, a heat collecting device with higher efficiency than plate-type heat collector could be selected as the heat source; according to the concept of 4 types of heating devices in the present invention, 1: the sunlight is directly radiated into the heating device; 2: the heating medium is used to transfer the heat from the heat source to the distiller; 3: electric power is used as the energy source; 4: latent heat released from condensed vapour is used as the heat source of the distiller.

### BRIEF DESCRIPTION OF THE DRAWINGS

FIG. 1 shows a schematic view of a conventional diffusion multiple-effect distillation system.

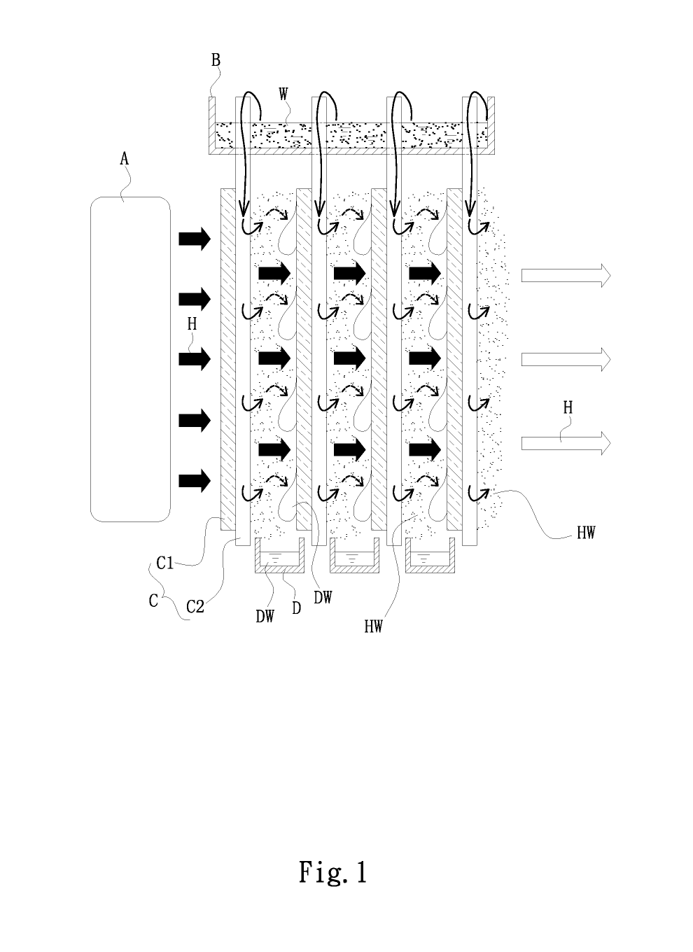

FIG. 2 shows a schematic view of the first preferred embodiment of the present invention.

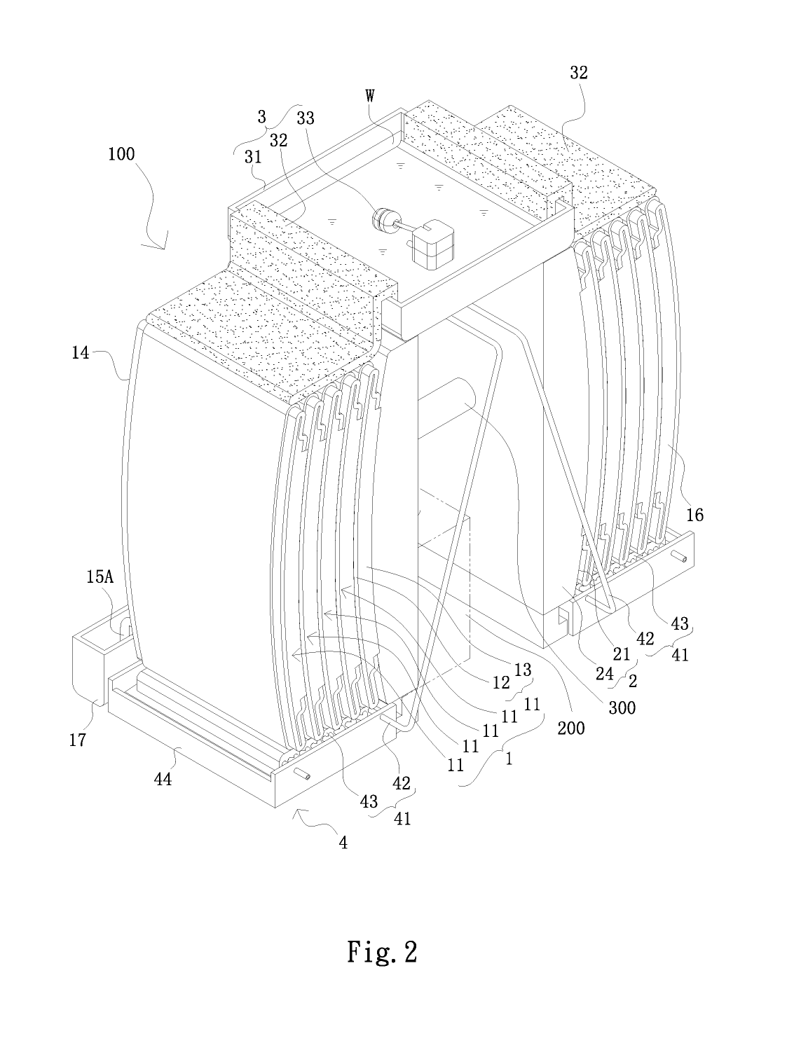

FIG. 3 shows an exploded perspective view of the first preferred embodiment of the present invention.

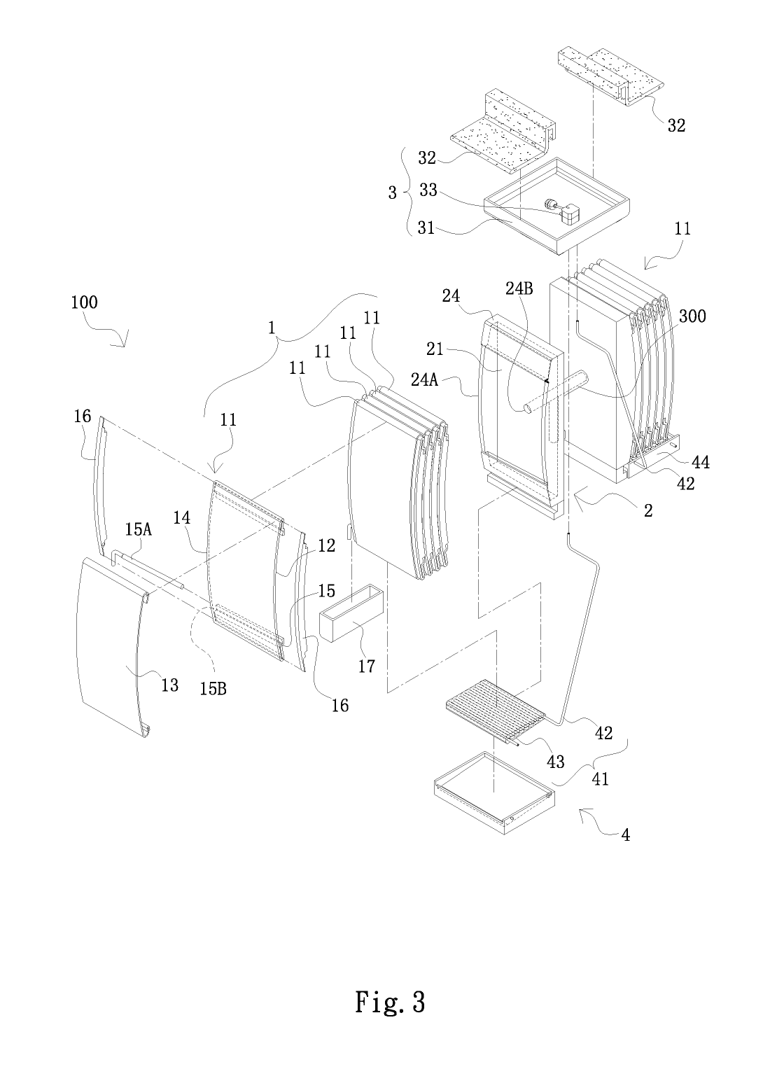

FIG. 4 shows a sectional view of the first preferred embodiment of the present invention.

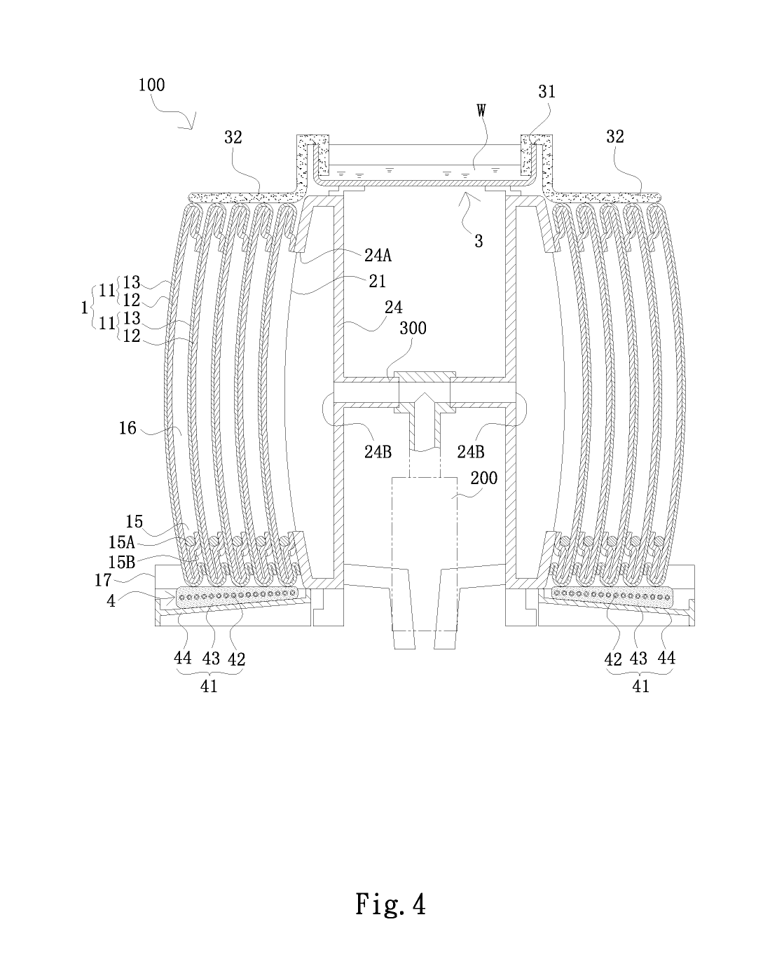

FIG. 5 shows a sectional view of the present invention showing the application status of the first preferred embodiment.

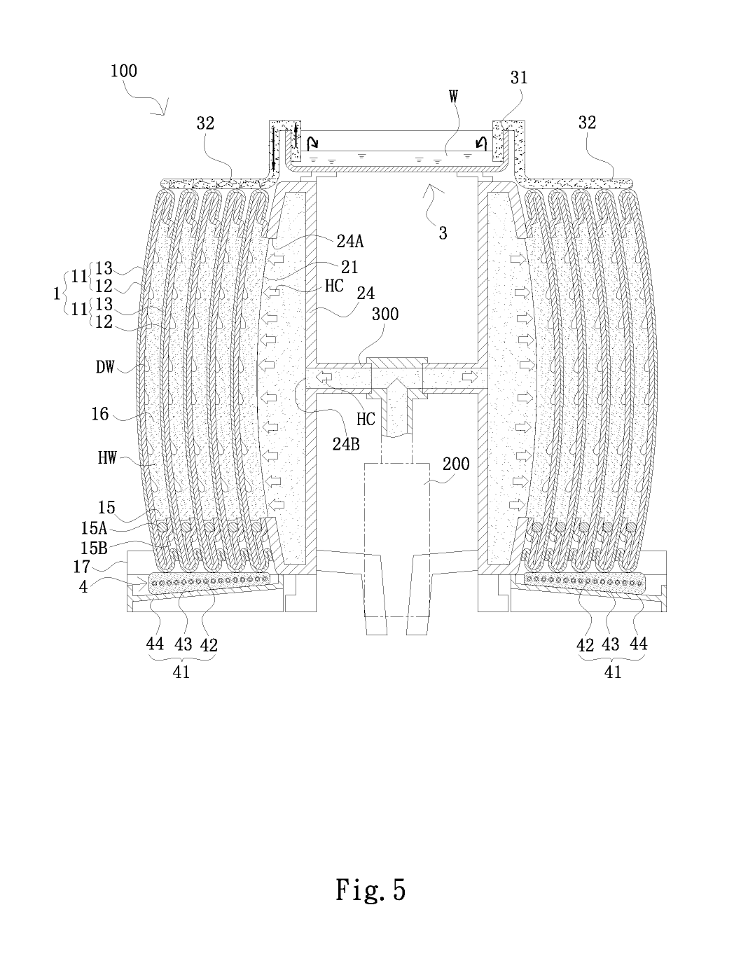

FIG. 6 shows a perspective view of the second preferred embodiment of the present invention.

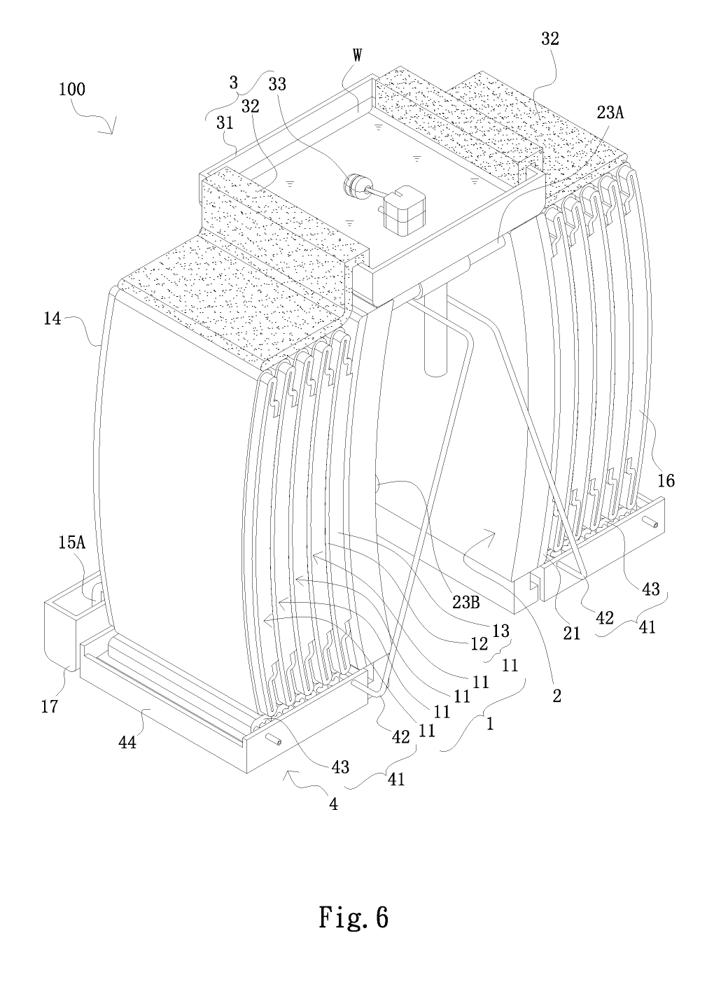

FIG. 7 shows an exploded perspective view of the second preferred embodiment of the present invention.

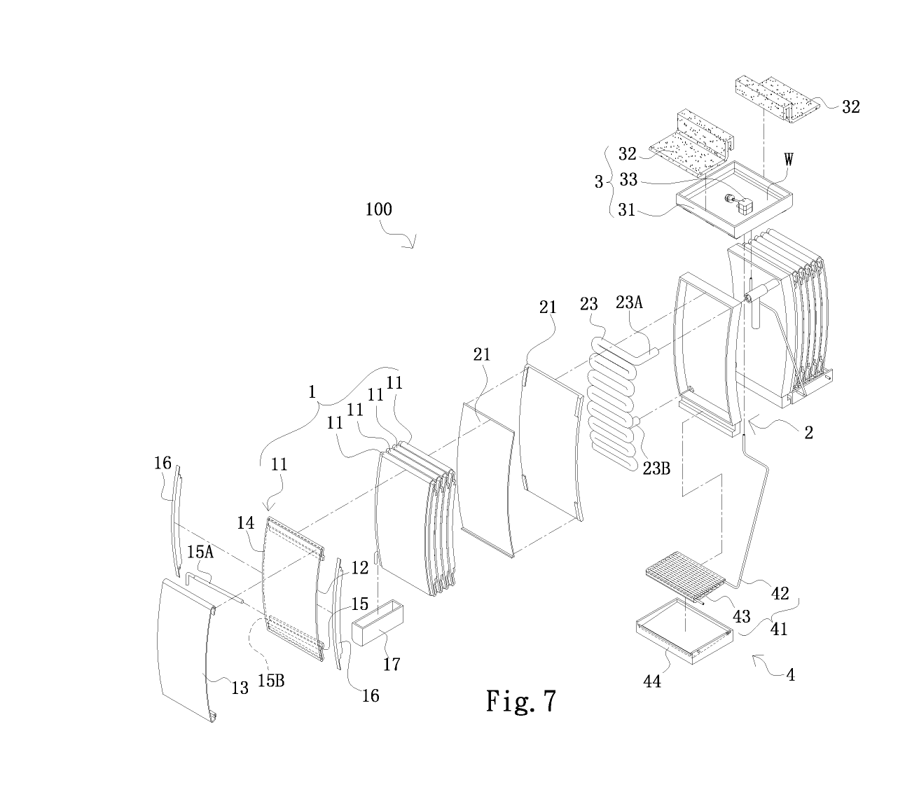

FIG. 8 shows a sectional view of the second preferred embodiment of the present invention.

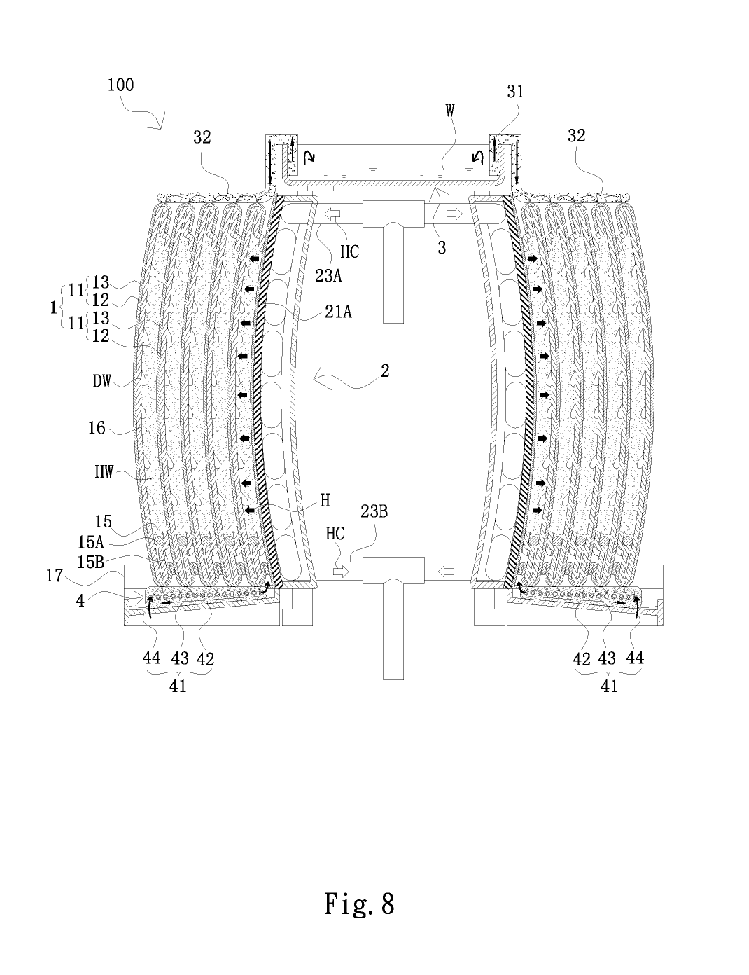

FIG. 9 shows a perspective view of the third preferred embodiment of the present invention.

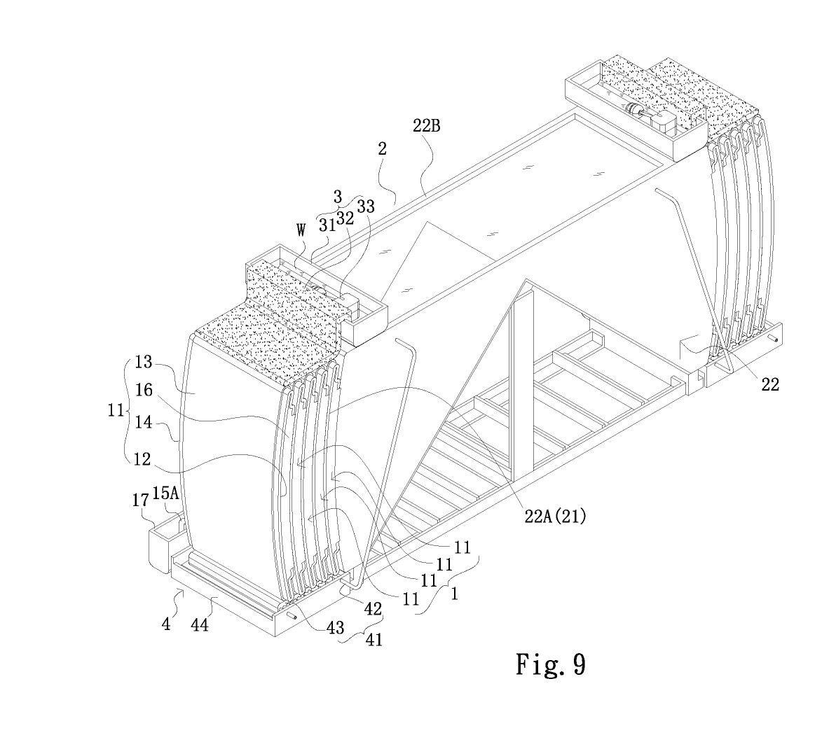

FIG. 10 shows an exploded perspective view of the third preferred embodiment of the present invention.

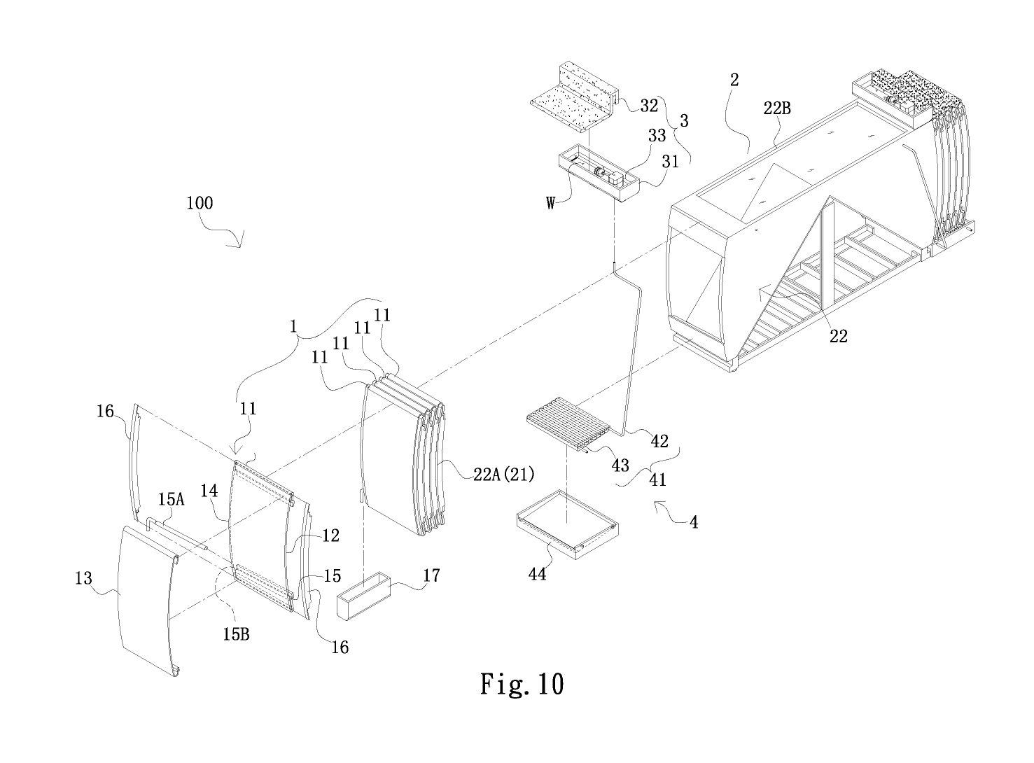

FIG. 11 shows a sectional view of the third preferred embodiment of the present invention.

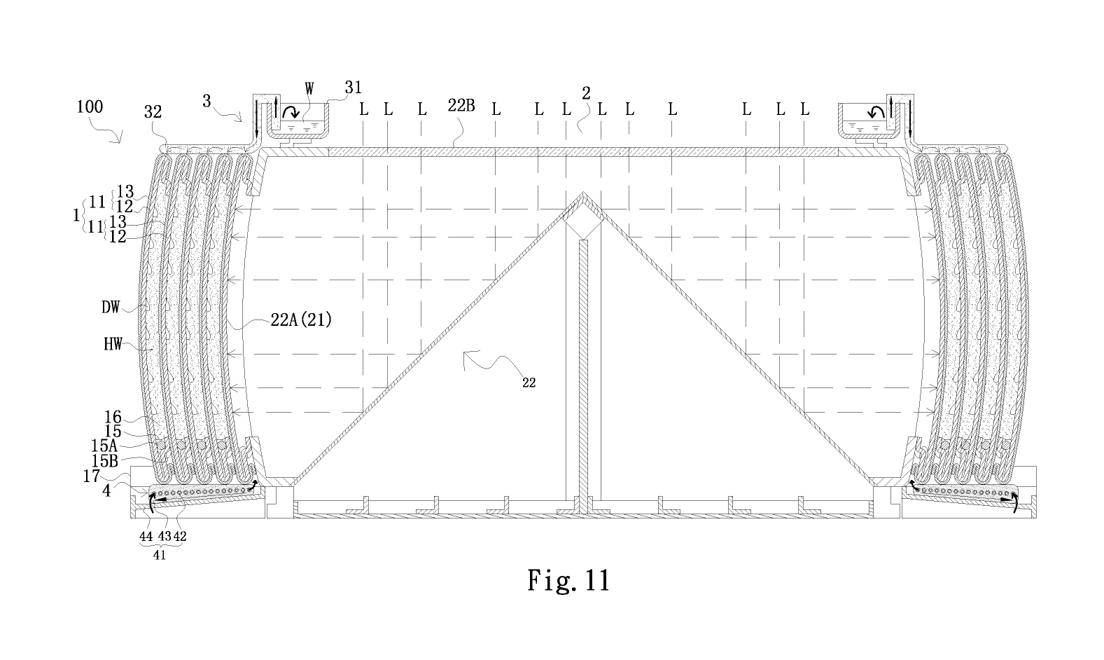

FIG. 12 shows a perspective view of the fourth preferred embodiment of the present invention.

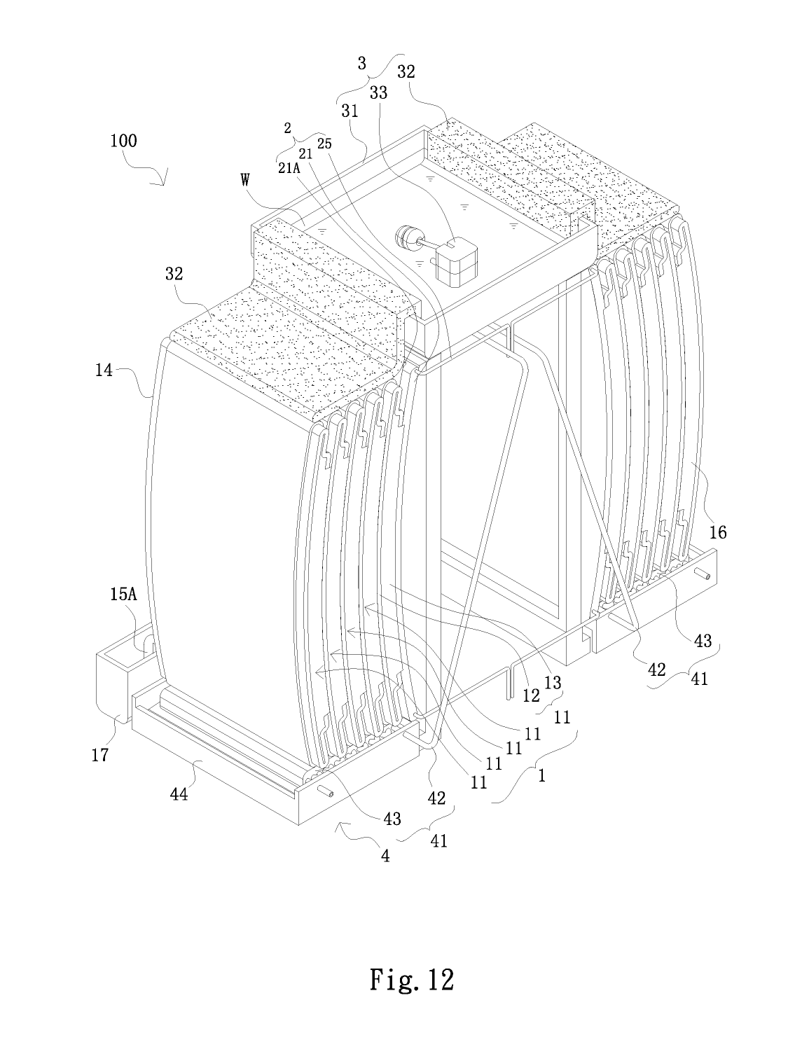

FIG. 13 shows an exploded perspective view of the fourth preferred embodiment of the present invention.

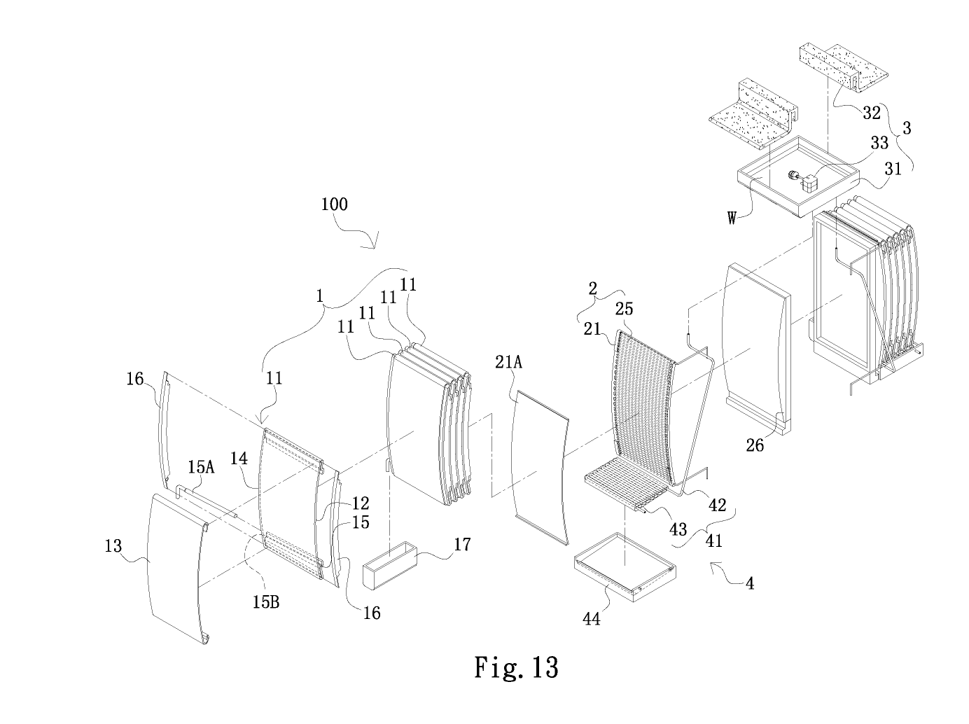

FIG. 14 shows a sectional view of the fourth preferred embodiment of the present invention.

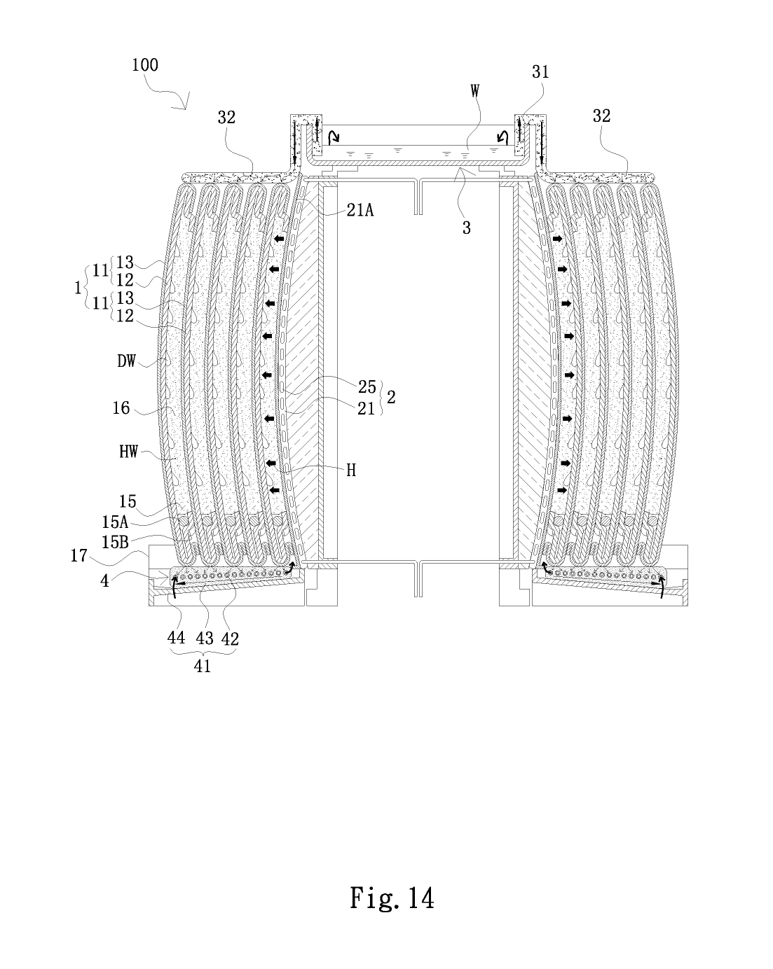

FIG. 15 shows a perspective view of the first preferred embodiment of another utility model.

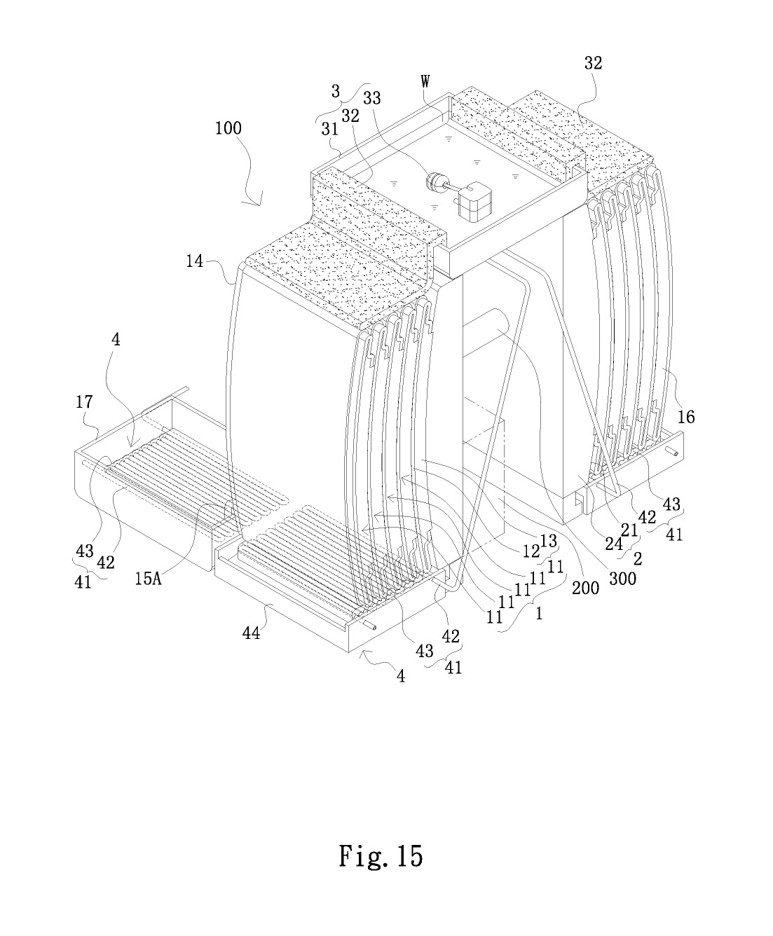

FIG. 16 shows a perspective view of a fluid container of another heating device of the present invention.

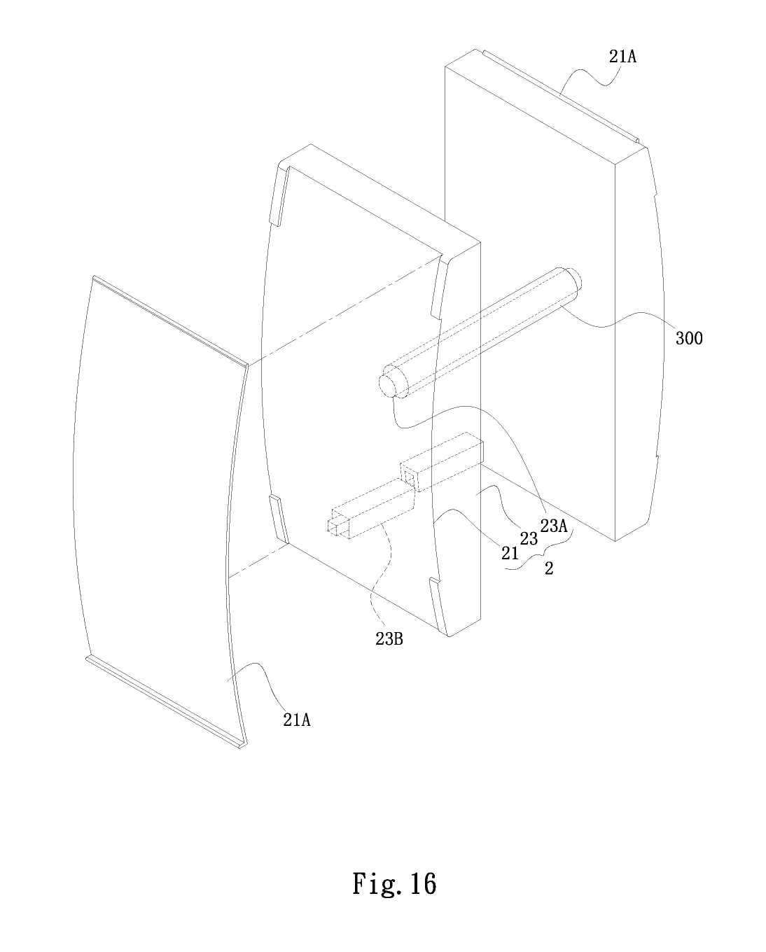

FIG. 17 shows a perspective view of the fifth preferred embodiment of the present invention.

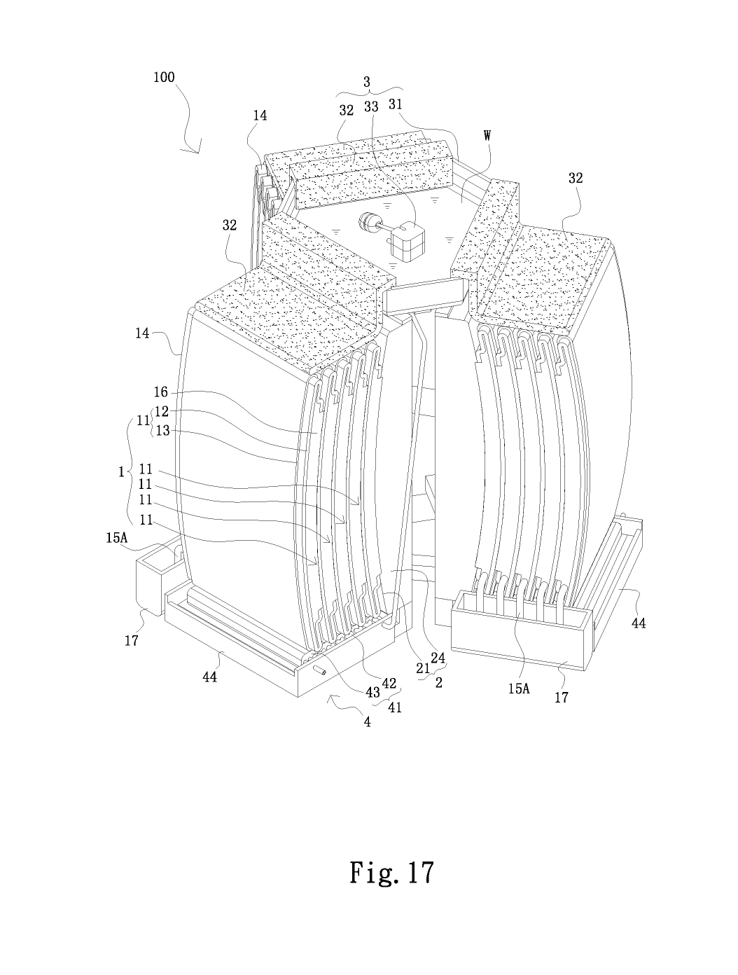

FIG. 18 shows a perspective view of the sixth preferred embodiment of the present invention.

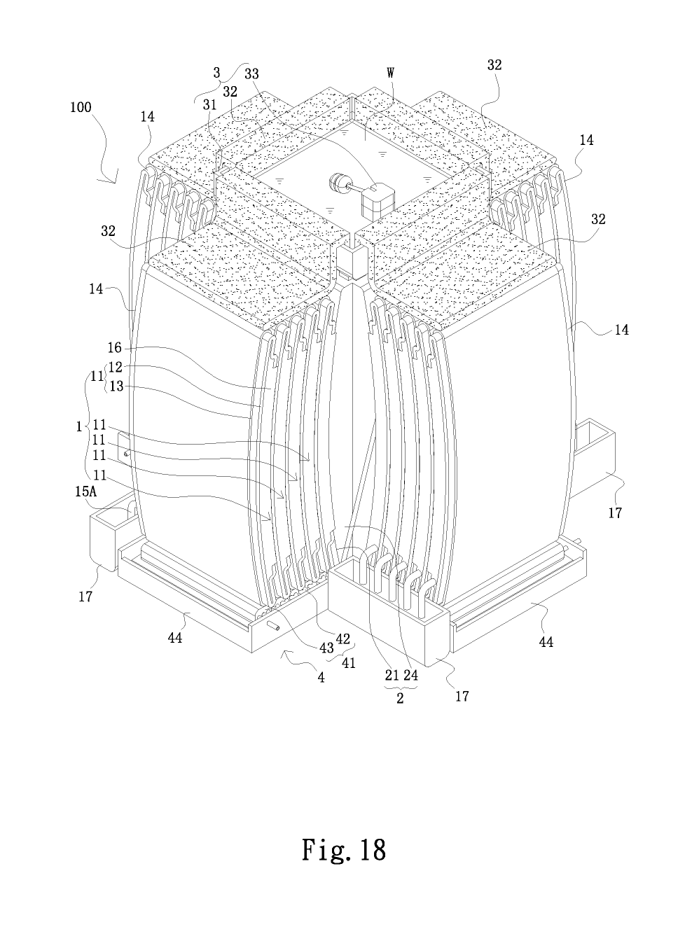

### DETAILED DESCRIPTION OF THE INVENTION

With use of the heat energy [e.g.: solar energy], water [water, sewage and water to be purified] is evaporated into vapour, which is then condensed into clean distilled water, so this involves water purification, seawater desalination, waste recovery and solar energy utilization, etc.

The following four technical means are introduced in the present invention:

1^{ST} technical means: a high-performance diffusion multiple-effect distillation system, which is characterized by that, it comprising:

a distillation system 100, comprising of a few distillers 1, a heating device 2 set between said distillers 1, and a water make-up device 3 set at top of the distiller 1;

said distiller 1 is composed of several distillation sheets 11; the distillation sheet 11 is of laminar structure, with its one surface taken as a condensing surface 12 for vapour (HW) condensation, and the other surface attached with an evaporating sheet 13 made of capillary material for evaporation purpose; a collecting ditch 15 is set below the condensing surface 12; the distillation sheets 11 are arranged in parallel away from the heating device 2 in the sequence of condensing surface 12 and evaporating sheet 13; and the periphery of the distillation sheets 11 is provided with a supporting structure 16 for preventing leakage of the vapour (HW);

said heating device 2 is provided with several heating surfaces 21; the heating surface 21 and the condensing surface 12 of corresponding distillation sheet 11 of the distiller 1 have a good thermal contact, or are incorporated to convert any kind of energy entering the heating device 2 into heat energy, and then transfer to the corresponding distiller 1 through the heating surface 21;

said water make-up device 3 is provided with at least a water tank 31 filled with water (W) to be distilled, and at least a water make-up body 32 made of capillary material; the level of water (W) in the water tank 31 is higher than the lowest point of said evaporating sheet 13; one end of the water make-up body 32 is dipped in water (W) of the water tank 31, and the other end is connected with the top of the evaporating sheet 13, enabling to guide water (W) from the water tank 31 to the evaporating sheet 13;

the distillation sheet 11 is provided with an arced surface 14, of which the concave surface is condensing surface 12, and the evaporating sheet 13 is covered onto the convex surface; moreover, evaporating sheet 13 is tightened at both ends of the arced surface 14 such that the evaporating sheet can be attached closely onto the distillation sheet 11.

2^{nd} technical means: its difference with the 1^{st} technical means lies in that:

the water make-up body 32 of said water make-up device 3 can be disassembled or replaced individually, and the water make-up body 32 is not prefabricated or fixed with said evaporating sheet 13.

3^{rd} technical means: its difference with the 1^{st} technical means lies in that:

Said distillation system 100 also comprises at least a heat recovery device 4;

said heat recovery device 4 comprises of a heat exchanger 41, which permits to preheat water (W) to be distilled by the residual heat from the waste water of distillation system 100 or from the distilled water (DW), or preheat the heat source 200 of the distillation system 100, and transfer heat energy to the heating medium (HC) of the heating device 2;

the heat exchanger 41 of the heat recovery device 4 comprises at least a fluid pipeline 42 with its one end linked to the water tank 31, or the heat source 200 of the distillation system 100; and

a fluid-choking device 43 made of capillary material covered onto the fluid pipeline 42.

4^{th} technical means: its difference with the 1^{st} technical means lies in that:

a diversion strip 15A is set separately into the collecting ditch 15 of the distillation sheet 11; the diversion strip 15A made of capillary material is extended out of the lowest outlet 15B of the collecting ditch 15, so as to discharge the distilled water (DW) of the collecting ditch 15.

Although the invention has been explained in relation to its preferred embodiment, it is to be understood that many other possible modifications and variations can be made without departing from the spirit and scope of the invention as hereinafter claimed.

1. A high-performance diffusion multiple-effect distillation system, which is characterized by that, it comprising:
a distillation system, comprising of a few distillers, a heating device set between said distillers and a water make-up device set at top of the distiller;
said distiller is composed of several distillation sheets; the distillation sheet is of laminar structure, with its one surface taken as a condensing surface for vapour condensation, and the other surface attached with an evaporating sheet made of capillary material for evaporation purpose; water to be distilled from the water make-up device can be adsorbed onto the evaporating sheet; a collecting ditch is set below the condensing surface to collect distilled water dripped from said condensing surface; the distillation sheets are arranged in parallel away from the heating device in the sequence of condensing surface and evaporating sheet; and the periphery of the distillation sheets is provided with a supporting structure for preventing leakage of the vapour; the heat energy from the corresponding heating device is transferred to the condensing surface of the distillation sheet closest to the heating device; and the heat energy is transferred to the evaporating sheet of the distillation sheet through the condensing surface, such that water adsorbed on the evaporating sheet is evaporated into vapour, which is then diffused to the condensing surface of opposite distillation sheet and condensed into distilled water; when the vapour is condensed into distilled water, the released latent heat is transferred to the evaporating sheet of the distillation sheet, where water contained therein is evaporated into vapour; similarly, vapour will be diffused to the condensing surface of a distillation sheet opposite to the aforementioned distillation sheet and condensed into distilled water; the distillation process is repeated until the heat energy is discharged out of the distillation system from the farthest distillation sheet of the heating device;
said heating device is provided with several heating surfaces; the heating surface and the condensing surface of corresponding distillation sheet of the distiller have a good thermal contact, or are incorporated to convert any kind of energy entering the heating device into heat energy, and then transfer to the corresponding distiller through the heating surface;
said water make-up device is provided with at least a water tank filled with water to be distilled, and at least a water make-up body made of capillary material; the level of water in the water tank is higher than the lowest point of said evaporating sheet; one end of the water make-up body is dipped in water of the water tank, and the other end is connected with the top of the evaporating sheet, enabling to guide water from the water tank to the evaporating sheet;
the distillation sheet is provided with an arced surface, of which the concave surface is condensing surface, and the evaporating sheet is covered onto the convex surface; moreover, evaporating sheet is tightened at both ends of the arced surface such that the evaporating sheet can be attached closely onto the distillation sheet.

2. The system defined in claim 1, wherein said distillation sheets could be assembled securely by either of the following ways: snapping, sleeving and screwing;
said evaporating sheets could be attached securely onto the distillation sheets through fixing two ends by either of the following ways:
clamped between two ends of the distillation sheets; gripped between two nearby distillation sheets; embedded simultaneously between two nearby distillation sheets during assembly.

3. The system defined in claim 1, wherein said heating device is a solar heating device;
said solar heating device is composed of several heat absorbing surfaces and a hood set at light incident side of the heat absorbing surface; the heat absorbing surface of dark color is used to absorb sunlight, while the hood enables the sunlight to transfer and/or concentrate on the heat absorbing surface.

4. The system defined in claim 1, wherein a fluid container, comprising of an inlet and outlet for guiding of heating medium, is distributed on the back of the heating surface of said heating device; said fluid container and the heating surface have a good thermal contact, or are incorporated;
after any kind of heating medium enters into the fluid container from the inlet of the fluid container and flows to the back of the heating surface, the heat of the heating medium is transferred to the heating surface, and taken away by the distiller; the heating medium after heat removal exits from the outlet of the fluid container;
an evaporating sheet is covered between the heating surface and nearby distillation sheet.

5. The system defined in claim 1, wherein the heating device is a tank, which is connected via a pipeline with the heat source of the distillation system, so as to obtain heated vapour transferred from the heat source;
said tank is provided with at least a vapour inlet, which is connected via a pipeline with the heat source of the distillation system, allowing the heating medium from the heat source to enter into the tank through the pipeline;
moreover, said tank is provided with several openings, so it can be used as a heating surface; with this structure, the condensing surface of the distillation sheet can be attached closely onto the tank and covered onto the openings.

6. The system defined in claim 1, wherein an electric heating device is set on the heating surface of said heating device, and used to convert electric energy into heat energy, and transfer to the distiller through the heating surface;
an evaporating sheet is covered between the heating surface and nearby distillation sheet.

7. The system defined in claim 1, wherein said distillation sheets are fabricated by either of the following sheets: flexible metal sheet, inflexible metal sheet, flexible high polymer sheet and inflexible high polymer sheet.

8. A high-performance diffusion multiple-effect distillation system, which is characterized by that, it comprising:
a distillation system, comprising of a few distillers, a heating device set between said distillers and a water make-up device set at top of the distiller;
said distiller is composed of several distillation sheets; the distillation sheet is of laminar structure, with its one surface taken as a condensing surface for vapour condensation, and the other surface attached with an evaporating sheet made of capillary material for evaporation purpose; water to be distilled from the water make-up device can be adsorbed onto the evaporating sheet; a collecting ditch is set below the condensing surface to collect distilled water dripped from said condensing surface; the distillation sheets are arranged in parallel away from the heating device in the sequence of condensing surface and evaporating sheet; and the periphery of the distillation sheets is provided with a supporting structure for preventing leakage of the vapour; the heat energy from the corresponding heating device is transferred to the condensing surface of the distillation sheet closest to the heating device; and the heat energy is also transferred to the evaporating sheet of the distillation sheet through the condensing surface, such that water adsorbed on the evaporating sheet is evaporated into vapour, which is then diffused to the condensing surface of opposite distillation sheet and condensed into distilled water; when the vapour is condensed into distilled water, the released latent heat is transferred to the evaporating sheet of the distillation sheet, where water contained therein is evaporated into vapour; similarly, vapour will be diffused to the condensing surface of a distillation sheet opposite to the aforementioned distillation sheet and condensed into distilled water; the distillation process is repeated until the heat energy is discharged out of the distillation system from the farthest distillation sheet of the heating device;
said heating device is provided with several heating surfaces; the heating surface and the condensing surface of corresponding distillation sheet of the distiller have a good thermal contact, or are incorporated to convert any kind of energy entering the heating device into heat energy, and then transfer to the corresponding distiller through the heating surface;
said water make-up device is provided with at least a water tank filled with water to be distilled, and at least a water make-up body made of capillary material; the level of water in the water tank is higher than the lowest point of said evaporating sheet; one end of the water make-up body is dipped in water of the water tank, and the other end is connected with the top of the evaporating sheet, enabling to guide water from the water tank to the evaporating sheet;
the water make-up body of said water make-up device can be disassembled or replaced individually, and the water make-up body is not prefabricated or fixed with said evaporating sheet.

9. A high-performance diffusion multiple-effect distillation system, which is characterized by that, it comprising:
a distillation system, comprising of a few distillers, a heating device set between said distillers and a water make-up device set at top of the distiller;
said distiller is composed of several distillation sheets; the distillation sheet is of laminar structure, with its one surface taken as a condensing surface for vapour condensation, and the other surface attached with an evaporating sheet made of capillary material for evaporation purpose; water to be distilled from the water make-up device can be adsorbed onto the evaporating sheet; a collecting ditch is set below the condensing surface to collect distilled water dripped from said condensing surface; the distillation sheets are arranged in parallel away from the heating device in the sequence of condensing surface and evaporating sheet; and the periphery of the distillation sheets is provided with a supporting structure for preventing leakage of the vapour; the heat energy from the corresponding heating device is transferred to the condensing surface of the distillation sheet closest to the heating device; and the heat energy is also transferred to the evaporating sheet of the distillation sheet through the condensing surface, such that water adsorbed on the evaporating sheet is evaporated into vapour, which is then diffused to the condensing surface of opposite distillation sheet and condensed into distilled water; when the vapour is condensed into distilled water, the released latent heat is transferred to the evaporating sheet of the distillation sheet, where water contained therein is evaporated into vapour; similarly, vapour will be diffused to the condensing surface of a distillation sheet opposite to the aforementioned distillation sheet and condensed into distilled water; the distillation process is repeated until the heat energy is discharged out of the distillation system from the farthest distillation sheet of the heating device;
said heating device is provided with several heating surfaces; the heating surface and the condensing surface of corresponding distillation sheet of the distiller have a good thermal contact, or are incorporated to convert any kind of energy entering the heating device into heat energy, and then transfer to the corresponding distiller through the heating surface;
said water make-up device is provided with at least a water tank filled with water to be distilled, and at least a water make-up body made of capillary material; the level of water in the water tank is higher than the lowest point of said evaporating sheet; one end of the water make-up body is dipped in water of the water tank, and the other end is connected with the top of the evaporating sheet, enabling to guide water from the water tank to the evaporating sheet;
said distillation system also comprises at least a heat recovery device;
said heat recovery device comprises of a heat exchanger, which permits to preheat water to be distilled by the residual heat from the waste water of distillation system or from the distilled water, or preheat the heat source of the distillation system, and transfer heat energy to the heating medium of the heating device;
the heat exchanger of the heat recovery device comprises at least a fluid pipeline with its one end linked to the water tank, or the heat source of the distillation system; and
a fluid-choking device made of capillary material for recycling the waste heat generated by the distillation system, covered onto the fluid pipeline, and capable of absorbing the waste heat from the distillation system as well as heat exchange with the fluid pipeline.

10. A high-performance diffusion multiple-effect distillation system, which is characterized by that, it comprising:
a distillation system, comprising of a few distillers, a heating device set between said distillers and a water make-up device set at top of the distiller;
said distiller is composed of several distillation sheets; the distillation sheet is of laminar structure, with its one surface taken as a condensing surface for vapour condensation, and the other surface attached with an evaporating sheet made of capillary material for evaporation purpose; water to be distilled from the water make-up device can be adsorbed onto the evaporating sheet; a collecting ditch is set below the condensing surface to collect distilled water dripped from said condensing surface; the distillation sheets are arranged in parallel away from the heating device in the sequence of condensing surface and evaporating sheet; and the periphery of the distillation sheets is provided with a supporting structure for preventing leakage of the vapour; the heat energy from the corresponding heating device is transferred to the condensing surface of the distillation sheet closest to the heating device; and the heat energy is also transferred to the evaporating sheet of the distillation sheet through the condensing surface, such that water adsorbed on the evaporating sheet is evaporated into vapour, which is then diffused to the condensing surface of opposite distillation sheet and condensed into distilled water; when the vapour is condensed into distilled water, the released latent heat is transferred to the evaporating sheet of the distillation sheet, where water contained therein is evaporated into vapour; similarly, vapour will be diffused to the condensing surface of a distillation sheet opposite to the aforementioned distillation sheet and condensed into distilled water; the distillation process is repeated until the heat energy is discharged out of the distillation system from the farthest distillation sheet of the heating device;
said heating device is provided with several heating surfaces; the heating surface and the condensing surface of corresponding distillation sheet of the distiller have a good thermal contact, or are incorporated to convert any kind of energy entering the heating device into heat energy, and then transfer to the corresponding distiller through the heating surface;
said water make-up device is provided with at least a water tank filled with water to be distilled, and at least a water make-up body made of capillary material; the level of water in the water tank is higher than the lowest point of said evaporating sheet; one end of the water make-up body is dipped in water of the water tank, and the other end is connected with the top of the evaporating sheet, enabling to guide water from the water tank to the evaporating sheet;
a diversion strip is set separately into the collecting ditch of the distillation sheet; the diversion strip made of capillary material is extended out of the lowest outlet of the collecting ditch, so as to discharge the distilled water of the collecting ditch.
